(19) United States
(12) Patent Application Publication
(10) Pub. No.: US 2006/0182816 A1
(43) Pub. Date: Aug. 17, 2006

(54) Hypobromous acid system

(76) Inventors: Tommy J. Shane, Loganville, GA (US); Harvey Swain, Lawrenceville, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/339,325

(22) Filed: Jan. 25, 2006

Related U.S. Application Data
(60) Provisional application No. 60/646,857, filed on Jan. 25, 2005.

(51) Int. Cl. A01N 59/00

(52) U.S. Cl. 424/723

(57) ABSTRACT

A system for producing hypobromous acid is provided. An exemplary system includes a carbonic acid source in fluid communication with a chlorinator element for producing a chlorinated carbonic acid solution, a bromine source in fluid communication with the chlorinated carbonic acid solution, wherein the combination of carbonic acid with the bromine source produces hypobromous acid solution, and controlling the pH of the hypobromous acid solution.

### CROSS-REFERENCE TO RELATED APPLICATION

This application claims the benefit of U.S. Provisional Patent Application No. 60/648,857 entitled “Hypobromous Acid System” filed on Jan. 25, 2005, incorporated herein by reference in its entirety.

### BACKGROUND

1. Technical Field

Aspects of this disclosure are broadly related to the field of disinfectants, and more specifically relate to systems and methods for producing and using hypobromous acid solutions to control contamination and/or pathogens, particularly in a food processing plant, such as a meat processing plant.

2. Related Art

Chlorine is a known sanitizing agent and is widely used in water treatment systems and cleaning products. U.S. Pat. No. 6,605,308 (which is incorporated by reference as if fully set forth herein) to Shane et al. discloses a system using hypochlorous acid for controlling pathogens. Although chlorine is a useful agent for controlling pathogens, it does have certain limitations. For example, once chlorine in a solution oxidizes a substance such as a pathogen, the chlorine is spent and can no longer continue to disinfect. Additional chlorine must be added to the solution to maintain the desired sanitation effects of the chlorine.

One particular use of sanitizing agents is to kill undesirable microorganisms in food processing lines, for example poultry processing lines. Since much of the poultry processing involves moving the bird on conveyers and human contact, provisions must be made to keep both the equipment and personnel sanitized.

For example, Salmonella is one of the most important causes of foodborne disease worldwide. In many industrialized countries the incidence of salmonellosis in humans and the prevalence of Salmonella in many food products have increased significantly over the last twenty years. Salmonella bacteria have a broad host-spectrum, and can be isolated from a wide range of animal species, including birds and reptiles. The animals usually are healthy carriers, and contaminated feed plays an important role in the epidemiology of salmonellosis. Salmonella can survive for a long time in the environment. Humans are usually infected through consumption of contaminated foods of animal origin. However, other food such as fresh produce, seafood and chocolate have also been implicated in outbreaks because of cross-contamination, use of contaminated water, use of manure as a fertilizer, presence of animals or birds in the production area or other factors.

In a typical poultry processing operation, freshly laid fertile eggs are collected and incubated. After they hatch, chicks are delivered to farms, reared until ready for slaughter and then transported to a processing plant. At the plant, the process of slaughtering includes several phases from unloading and shackling the live birds to grading and packaging the carcasses. Then, carcasses are shipped and distributed chilled or frozen while some poultry carcasses are used for portioning and/or to produce a variety of raw or processed products. The microbiological condition of poultry carcasses is highly dependent on the manner in which animals are reared and slaughtered. The microbiological condition of live birds influences the microbiology of the products and the live animals are the principal source of microorganisms found on poultry carcasses. At the processing plant, the conditions of slaughtering will further influence the extent to which processed poultry will be contaminated.

There are many sources of contamination during poultry processing. Commercially grown poultry flocks are collected on the farm, placed into crates, transported to the processing plant and slaughtered on the same day. Contaminated crates can be a significant source of Salmonella and E. coli on processed carcasses. Contamination of feathers with microorganisms of fecal origin increases as birds are confined in crates for transport to the plant and microorganisms in feces and on feathers can be spread from bird to bird within the crates. Stress of transportation may amplify the pathogen levels. In one study, fecal droppings collected in broiler houses about one week prior to slaughter were contaminated at a rate of 5.2% while Salmonella was found in 33% of the samples collected from live-haul trucks at the processing plant.

During hanging, as feathers, feet and bodies are contaminated with a variety of bacteria, wing flapping creates aerosols and dust, contributing to contamination of the unloading zone and transmission of pathogens at this stage.

Stunning and killing have few microbiological implications, although electrical waterbath stunning may lead to inhalation of contaminated water by the birds and microbial contamination of carcass tissues.

During scalding, soil, dust and fecal matter from the feet, feathers, skin and intestinal tract are released into the scald water and thus provide a significant opportunity for cross contamination. A large variety of bacteria, e.g., Salmonella, Staphylococcus, Streptococcus, Clostridium spp. have been isolated from scald water or from carcasses or air sacs immediately after scalding.

Bacterial survival in the scald water is influenced by scald temperature and time. The lethal effect of water held at 60° C. (hard scald) used for carcasses intended for water chilling is measurable and greater than the lethal effect of water held at lower temperatures, e.g. 50-52° C. (soft scald) as used for carcasses that will be air chilled.

It has also been demonstrated that scalding results in modifications to the poultry skin: removal or damage of the epidermal layer, exposing a new surface for contamination which is smoother and less hydrophobic, exposure of microscopical channels and crevices. During and after scalding, the skin surface retains a film of scalding water which contains organic matter and large numbers of bacteria. Some of these bacteria may adhere more easily to the modified surface of the skin. Some may be retained in the channels or crevices on the skin surface as well as in the feather follicles. During the following stage of defeathering, there may be entrapment of bacteria in the channels, crevices and follicles. When entrapped, the bacteria may be difficult to remove by subsequent procedures, including mechanical and chemical decontamination treatments; they also display greater heat resistance.

Defeathering with automatic machinery may be expected to cause considerable scattering of microorganisms in particular via aerosols. Early findings, from work being carried out in the United Kingdom, indicate that these aerosols from defeathering can be reduced by altering the design of the equipment. Conditions inside the machines are favorable to the establishment of a biofilm and colonization by pathogens, in particular S. aureus which can survive, multiply and become indigenous to the equipment. Defeathering has been recognized as a major source of carcass contamination with S. aureus, Salmonella, Campylobacter spp and E. Coli. Several studies have established that the microbial populations on poultry carcasses reflect the microbiological condition of the carcasses immediately after defeathering.

Evisceration can give rise to fecal contamination with enteric pathogens such as Salmonella, Campylobacter and Cl. perfringens, especially when intestines are cut and/or when automatic machines are not set properly. In addition, microorganisms may be transferred from carcass to carcass by equipment, workers, and inspectors.

Spray washing of carcasses removes visible fecal contamination and some microorganisms such as Salmonella and E. Coli. However, it does not eliminate those bacteria that have become attached to the carcass surface or entrapped in the inaccessible sites of the skin surface. It has been demonstrated that continuous carcass washing or applying a series of sprays at the various stages of evisceration removes bacteria before they are retained, and this is much more effective than a single wash after evisceration. There is a danger that use of water sprays, in particular those used in carcass washing, may create aerosols that can spread microbiological contamination.

Three types of chilling processes may be used: air blast, water immersion and a combination of air and water chilling. All three methods may lead to some degree of cross contamination. With regard to the final microbiological load on the carcass, it has been demonstrated that properly controlled water immersion chilling can reduce overall levels of carcass contamination. However, high levels of contamination of carcasses before chilling and insufficient water used per carcass (amount of fresh water replacement; number of carcasses in relation to the volume of chilled water) may result in an increase in the level of microbial contamination on carcasses rather than a decrease.

There have been numerous studies to determine the relative effect of each processing step on carcass contamination. Generally, the results show that aerobic plate counts or count of Enterobacteriaceae decrease during processing.

The data on the prevalence of Salmonella contaminated carcasses are highly variable. The proportion of contaminated carcasses appears to be influenced mainly by the condition of incoming birds and also by processing. Although the prevalence of Salmonella contaminated carcasses can be high, the number of Salmonella per carcass is usually quite low. In comparison with Salmonella, campylobacters are generally carried in high numbers by poultry. Therefore carcasses are more readily contaminated during processing and the numbers present are correspondingly higher.

Sanitizing agents, such as antimicrobial compounds, have been used for disinfecting products and equipment surfaces for many years. Some of the agents that have been approved for use are: hot water, steam, lactic acid spray, acetic acid spray, citric acid spray, trisodium phosphate, chlorine dioxide, acidulated sodium chlorite, and sodium hypochlorite (bleach). Hot water is generally not used with poultry products because hot water can scorch surfaces, resulting in a “cooked” appearance. This is especially crucial if the end product is to be deboned unfrozen or fresh breast fillets. Steam pasteurization procedures have recently been developed and have been shown to be very effective against bacteria; however, applying steam to individual carcasses moving down a processing line at 70 to 140 carcasses per minute is challenging. Thus, the industry has been slow to incorporate this type of treatment.

Organic acids are excellent for killing bacteria because they penetrate and disrupt the cell membrane and dissociate the acid molecule, thereby acidifying the cell contents. They are stable in the presence of organic material, such as blood or feces and they are fairly inexpensive to use. Acids are susceptible to water pH problems (such as high incoming water pH), they may cause product defects, such as off flavors, odors, and colors, even when used at low levels. Additionally, organic acids may corrode equipment.

Trisodium phosphate (TSP) is becoming more widely accepted and used, because the USDA is encouraging its use within the industry. TSP is costly to use because of the quantity needed to disinfect carcasses. There are negative aspects to using TSP in poultry processing plants that should be considered. Residual TSP on carcasses causes the chiller water pH to increase dramatically. In plants where TSP is used, the chiller water will generally be in the pH range of 9.7 to 10.5.

Chlorine dioxide has been evaluated in processing plants and seems to be effective for killing bacteria at very low concentrations; however, it is expensive to generate and very difficult to maintain at a particular concentration in chiller water. Some USDA inspection personnel have been reticent to allow its use in plants.

Thus, there is a need for improved systems and methods for providing sanitizing agents and solutions, in particular for food processing plants.

### SUMMARY

The present disclosure addresses the aforementioned need. Aspects of the disclosure provide systems and methods for producing sanitizing agents and sanitizing solutions comprising hypochlorous acid, hypobromous acid, and combinations thereof. The disclosed systems and methods are useful for controlling contamination of foodstuffs, in particular fowl, meat, vegetables, and for controlling contamination in food processing lines, for example poultry processing lines.

One aspect provides a system and method for providing a bromine solution, for example an aqueous bromine solution, adding an oxidizer to the bromine solution to form hypobromous acid solution, controlling the pH of the hypobromous acid solution to about 8.5 or less, typically between about 6 and about 8, and using the hypobromous acid solution to control contamination of food.

Another aspect provides a system and method for producing hypobromous acid solution comprising a carbonic acid source in fluid communication with a chlorinator element for producing a chlorinated carbonic acid solution, a bromine source in fluid communication with the chlorinated carbonic acid solution, wherein the combination of the carbonic acid with the bromine produces hypobromous acid solution, and a system for controlling the pH of the hypobromous acid solution.

In certain aspects, hypobromous acid solution is generated by a pressurized solution system that produces a chlorinated carbonic acid solution using carbon dioxide gas and a make-up water source, such as that disclosed in U.S. Pat. No. 5,514,264, which patent is incorporated by reference as if fully set forth herein. The chlorinated carbonic acid solution is mixed with bromine to form hypobromous acid solution. By controlling the pH of the hypobromous acid solution, using for example carbonic acid, the combination of the chlorinated carbonic acid solution and the bromine solution can form up to a 98% hypobromous acid solution that can be used in food processing lines, for example into the chillers or washing systems to control the contamination of food including meat, fowl, and vegetables with undesirable organisms such as bacteria, protozoa, fungi, viruses, parasites, among others.

It can be seen, therefore, that in one aspect of the present disclosure systems and methods for producing improved sanitizing agents and solutions are provided for controlling contaminants and/or reducing pathogens in a food processing plant.

Other systems, devices, methods, features and advantages of the disclosed systems and methods will be or become apparent to one with skill in the art upon examination of the following drawings and detailed description. It is intended that all such additional systems, devices, methods, features, and advantages be included within this description, be within the scope of the present invention, and be protected by the accompanying claims.

### BRIEF DESCRIPTION OF THE DRAWINGS

Many aspects of the disclosed systems can be better understood with reference to the attached drawings, FIGS. 1-3. The components in the drawings are not necessarily to scale, emphasis instead being placed upon clearly illustrating the principles of the present invention. Moreover, in the drawings, like reference numerals do not need corresponding parts throughout the several views. While several embodiments are described in connection with these drawings, there is no intent to limit the disclosure to the embodiment or embodiments disclosed herein. On the contrary, the intent is to cover all alterations, modifications and equivalents.

FIG. 1 shows a diagram of an exemplary embodiment of a contamination control system according to one aspect of the present disclosure.

FIG. 2 shows a diagram of an exemplary embodiment of a hypobromous acid component of the disclosed systems of FIG. 1.

FIG. 3 shows an exemplary method according to one embodiment of the disclosure.

### DETAILED DESCRIPTION

Embodiments of the disclosed systems and methods for controlling contamination incorporate sanitizers such as chlorine, bromine, hypochlorous acid, hypobromous and combinations thereof. Certain embodiments provide a system and method for producing a pressurized solution comprising hypochlorous acid and bromine to produce a solution containing hypobromous acid. Generally, the concentration of the sanitizers in the solution is in an amount sufficient to kill, inactivate, inhibit growth of, or inhibit reproduction of organisms present on a surface treated with the pressurized solution. Generally the surface to be treated comprises a carcass surface or foodstuff surface.

Hypobromous Acid

Hypobromous acid (chemical formula HOBr) is the active or killing form of bromine and reacts with bacteria and organics. In some embodiments, liquid bromine is added to water to form hypobromous acid and hypobromite ions (chemical formula OBr⁻).

Bromine is 2.25 times heavier than chlorine, and at a pH of 7.5 the killing form of bromine (hypobromous acid, HOBr) is at 94% and the oxidizing form (hypobromite ion OBr⁻) is at 6% (Table 1). When the pH of a bromine containing solution is between 6.5 and 9 both hypobromous acid and hypobromite ions are present. But hypobromous acid can react with certain chemicals in the water that tie up the bromide ions and prevent them from becoming free bromide ions in the water. This happens when hypobromous acid produces bromate or bromoform for instance. There are many other combinations that tie up the bromine so it can not become free bromide ions. Typically, the level of bromide ions should not go below 15 ppm.

In one embodiment, a salt of bromine (e.g., sodium bromide) is added to an aqueous solution to produce bromide ions. An oxidizer such as monopersulfate (MPS), hydrogen peroxide, percarbonate, ozone or any compound of chlorine is combined with the solution containing bromide ions to produce hypobromous acid solution. The pH of the hypobromous acid solution is maintained, for example using carbonic acid, at 8.5 or less, typically less than 7.5, more typically between about 6.0 and 8.0 cause a greater percentage of the bromine in the solution to be in the form of hypobromous acid (HOBr) than hypobromite ion (OBr—).

Bromine is commercially available. A suitable source of bromine, includes, but is not limited to 1-bromo-3-chloro-5,5-dimethylhydantoin. When added to water the tablets hydrolyze to become hypobromous acid. With bromine tablets a separate oxidizer is not necessary to make hypobromous acid, it is already an ingredient in the tablets. When the hypobromous acid reacts with a contaminant and is reduced, it becomes a bromide ion. The bromide ions can then be converted back into hypobromous acid by an oxidizer such as hypochlorous acid to reactivate the bromide ions. In certain embodiments, the sanitizing solution comprises about 15 ppm or more of bromine ions in the water. The addition of chlorine, for example hypochlorous acid, converts the bromine ions into hypobromous acid, and a chlorine residual and the formation of a chlorine residual is inhibited or prevented.

TABLE 1

| Hypobromous acid (HOBr) | | Hypobromite ion (Obr−) |
|---|---|---|
| % bromine as HOBr | pH | % bromine as OBr− |
| 100 | 6.0 | 0.0 |
| 99.4 | 6.5 | 0.6 |
| 98 | 7.0 | 2 |
| 94 | 7.5 | 6 |
| 83 | 8.0 | 17 |
| 57 | 8.5 | 43 |

Hypobromous acid combines with ammonia and nitrogen compounds in water to form bromamines. Bromamines are active sanitizers, and they do not have the foul-smell of chloramines.

One embodiment incorporates the use of hypobromous acid as a pathogen control medium. An exemplary pathogen management system comprises utilizing a hypobromous acid solution stream at a pH of between about 6 and 8.5, typically at about 6 to about 7.5, more typically at about 6.5 to about 7.0. The hypobromous acid stream can be used to reduce, control, or eliminate microorganisms including pathogens in, for example, poultry processing plants. It will be understood that the disclosed systems are not so limited to poultry or fowl processing, and can be used as a pathogen management system in numerous food processing applications, in particular other meat processing applications.

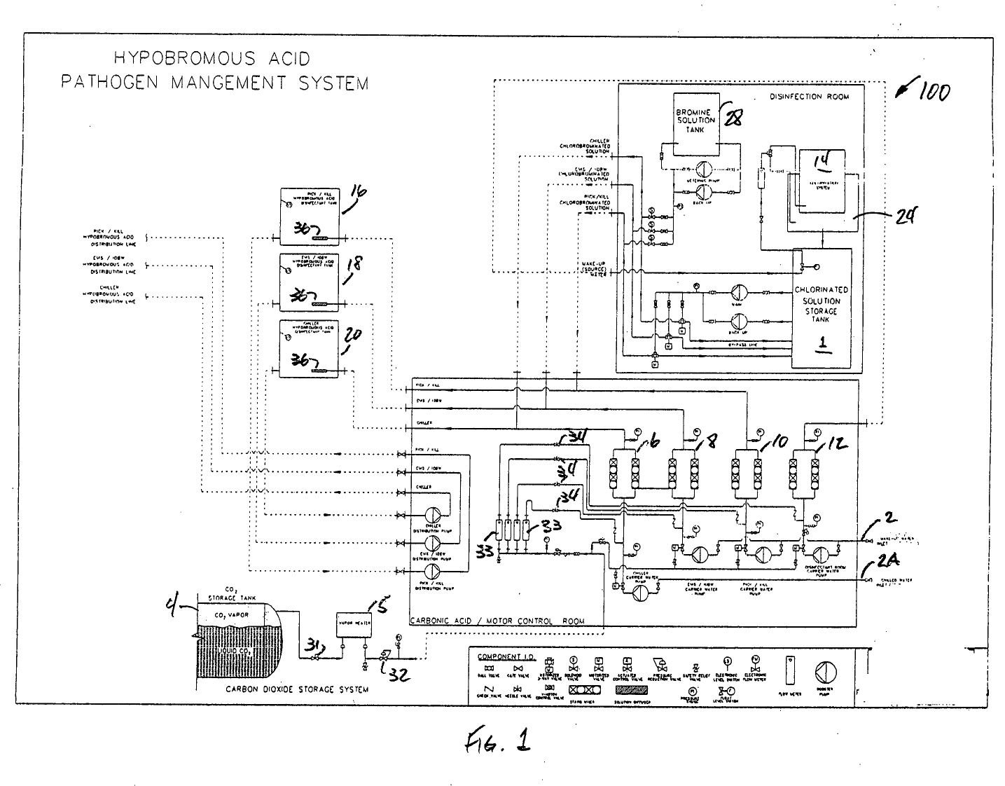

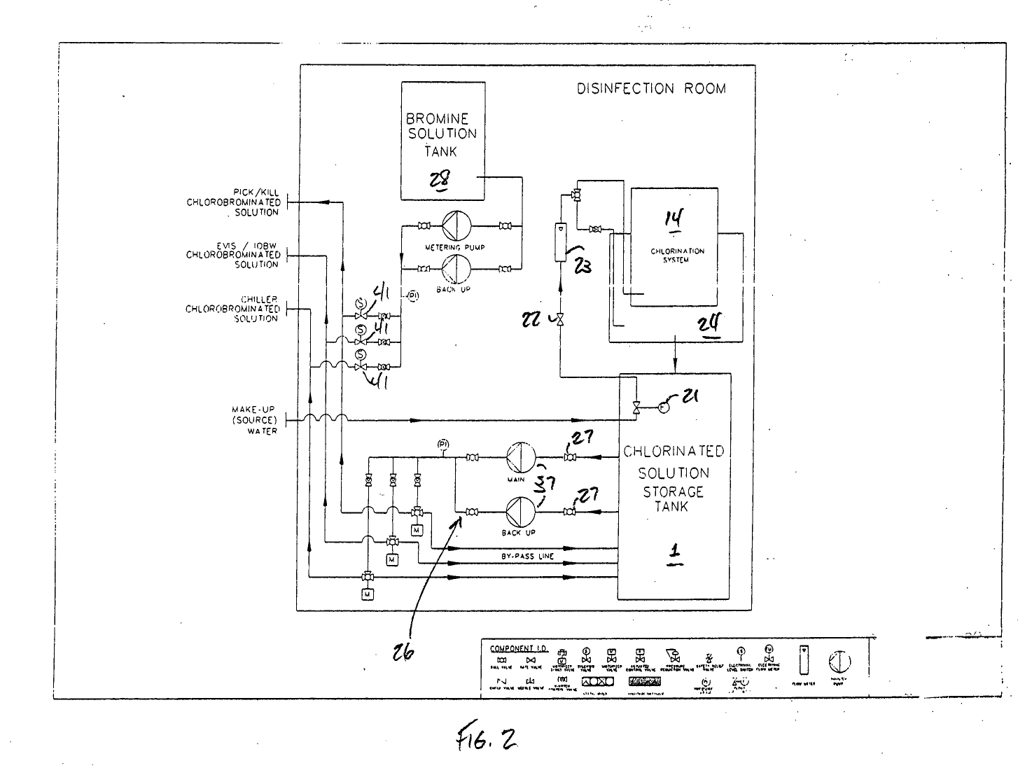

FIGS. 1-2 refer to a diagram of an exemplary system 100 for controlling contamination, for example contamination in a food processing line. Source water or make-up water enters system 100 though line 2 and is combined with carbon dioxide and mixed in static minters 6, 8, 10 and 12 to produce carbonic acid solution. Generally, the source water is pressurized, for example at least about 25 psig, preferably about 50 psig. In one embodiment, carbon dioxide gas is introduced into system 100 from a carbon dioxide source 4. The carbon dioxide gas goes through an isolation ball valve 31, a vapor heater 5, optionally a wye strainer (not shown), then a pressure reduction valve 32. After the pressure reduction valve 32, the carbon dioxide gas goes through a flow meter 33 and then to a metering control valve 34. The control adjusts the dosage of carbon dioxide according to the pH deviation from a setpoint. Accordingly, the pH of the carbonic acid solution is regulated to a predetermined pH or range of pH.

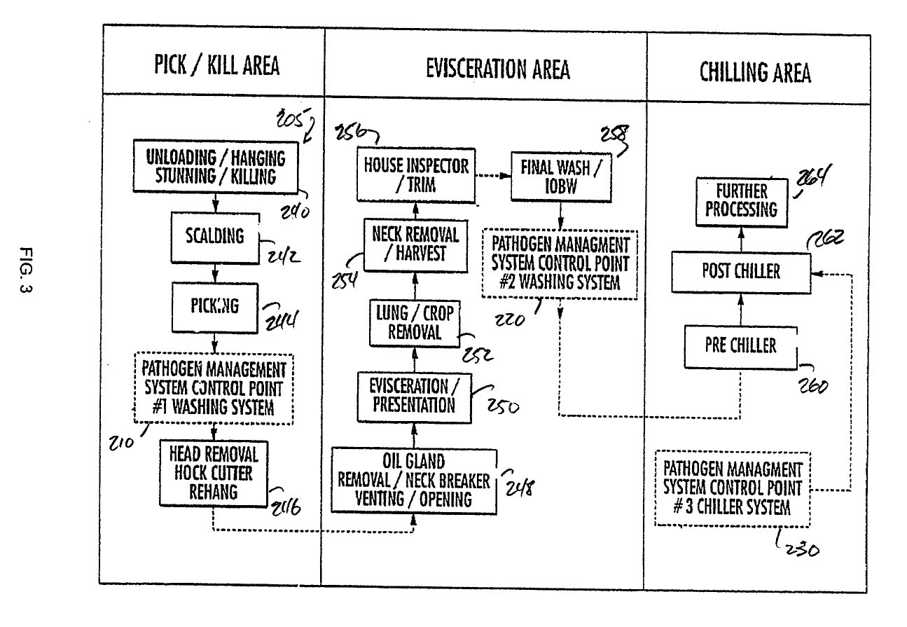

After the control valve 34, the carbon dioxide goes through a check valve 35 and then through an injector (not shown) for injecting the carbon dioxide into a pressurized make-up water stream 2, 2A. The pressure of make up water streams 2, 2A is typically at least 25 psig, preferably about 50 psig. The injection of carbon dioxide into high pressure make-up water forms the carbonic acid solution. U.S. Pat. No. 5,514,264, which is incorporated by reference in its entirety, discloses a suitable system for producing pressurized carbonic acid solutions. The carbonic acid solution is mixed with static mixers 6, 8, 10, 12 and then goes to the diffusers 36, which control the flow rate and the line pressure. The carbonic acid solution can then be delivered to chlorination system 14, pick/kill storage tank 16, evisceration storage tank 18, or chiller storage tank 20. Hypobromous acid solution can then be delivered from these tanks to any one or more washing/sanitizing devices located in the respective areas of the processing line (see FIG. 3).

The carbonic acid solution from static mixer 12 goes through a float switch 21 to protect the system from over flowing. After float switch 21, the carbonic acid solution goes through a gate valve 22, which can adjust the carbonic acid solution to regulate the amount of solution delivered to chlorinator 14. The carbonic acid solution travels through rotometer 23 at a predetermined rate set by a control valve.

The carbonic acid solution is then split either to chlorinator 14 or to the outer mixing chamber 24 or both. By allowing a controlled amount of carbonic acid solution into chlorinator 14, the concentration of chlorine in the chlorinated carbonic acid solution can be regulated. This chlorinated carbonic acid solution is gravity feed into outer chamber 24, where it can be mixed with the bypassed carbonic acid solution.

From outer chamber 24, the chlorinated carbonic acid solution gravity feeds into the chlorinated carbonic acid solution storage tank 25. The chlorinated carbonic acid solution is pumped 37 into a loop system 26 at a given rate via control valves 27. The chlorinated carbonic acid solution is either reintroduced into chlorinated solution storage tank 25 as bypass or is sent to tanks 16, 18, or 20.

As the chlorinated carbonic acid solution is delivered to tanks 16, 18, or 20, a bromine solution is introduced from a bromine solution tank 28 into the chlorinated carbonic acid solution. The amount of bromine solution combined with the chlorinated carbonic acid solution is regulated to a selected rate via a control valve 41. The combination of the bromine solution with the chlorinated carbonic acid solution produces a chlorobrominated solution comprising hypobromous acid. The hypobromous acid solution is combined with carbonic acid solutions from static mixers 6, 8, or 10 downstream of the carbon dioxide injection system and delivered to tanks 16, 18, and 20. The hyprobromous acid solution can then be used to control microorganisms on a target surface such as a carcass.

In the chlorinated carbonic acid solution HOCl and OCl⁻ are generally present in a pH dependent equilibrium. The pKa of hypochlorous acid is about 7.53. As shown in Table 2, at low pH, HOCl is the predominant form, while at high pH, OCl⁻ predominates:

TABLE 2
Percent HOCl pH/Temp. ° C.

| | 0 | 5 | 10 | 15 | 20 | 25 | 30 |
|---|---|---|---|---|---|---|---|
| 5.0 | 99.85 | 99.83 | 99.80 | 99.77 | 99.74 | 99.71 | 99.68 |
| 5.5 | 99.53 | 99.75 | 99.36 | 99.27 | 99.18 | 99.09 | 99.01 |
| 6.0 | 98.53 | 98.28 | 98.01 | 97.73 | 97.45 | 97.18 | 96.92 |
| 7.0 | 87.05 | 85.08 | 83.11 | 81.17 | 79.23 | 77.53 | 75.90 |
| 8.0 | 40.19 | 36.32 | 32.98 | 30.12 | 27.62 | 25.65 | 23.95 |
| 9.0 | 6.30 | 5.40 | 4.69 | 4.13 | 3.68 | 3.34 | 3.05 |
| 0.0 | 0.67 | 0.57 | 0.49 | 0.43 | 0.38 | 0.34 | 0.31 |
| 11.0 | 0.067 | 0.057 | 0.049 | 0.043 | 0.038 | 0.034 | 0.031 |

As noted above, the chlorinated carbonic acid solution reacts with the bromine solution to produce hypobromous acid. In one embodiment, substantially all of the hypochlorous acid reacts with the bromine solution to produce a solution of about 90% or more of hypobromous acid, and about 10% or less of hypochlorous acid, typically about less than 1% of the hypochlorous acid solution remains unreacted with the bromine solution. In other embodiments, a solution of about 1:1, 1:2, 1:3, 1:4, or 1:5 hypobromous acid to hypochlorous acid is produced by the disclosed systems.

In a particular application of the disclosed systems and methods, fowl (not shown) enter a processing line and are unloaded, hanged, stunned and killed. The fowl are then scalded, picked, and washed. Hypobromous acid solution is applied to the fowl to clean the organic load off the exterior of the carcass.

FIG. 3 illustrates a block diagram of an exemplary poultry processing line 5 utilizing one or more locations of application of the present hypobromous acid solution as a sanitizing agent to the process. For example, hypobromous acid solution can be at one or more of a first washing system 210, second washing system 220 and third washing system 230. In a preferred embodiment, the acid solution is used in all three such systems. One skilled in the art will recognize that the hypobromous acid solution can be added to any system or station that uses a water or a sanitizing solution wash. For example, hypobromous acid can be delivered to and used in conjunction with one or more of an inside/outside bird washer of a mechanical brush cabinet of the type described in U.S. Pat. No. 6,605,308 (which is incorporated by reference as if fully set forth herein) that may be located in the evisceration area of a poultry plant, or a spray cabinet located after the bird scalding stage and before the first picker, in scald water make up water, a “New York” spray cabinet or a hock cutter that may be typically located in the pick/kill area of the plant, or a pre-scald mechanical brush cabinet. The acid solution can also be used to wash the bird rails that carry the bird through the plant.

Birds (not shown) enter the processing line 205, and are unloaded, hanged, stunned and killed at step 240. The birds are then scalded 242, picked 244, and enter washing system 210. This first pathogen reduction location 210 is in the pick/kill room of the plant. Hypobromous acid solution is added to the washing system 210 to clean the organic load off the exterior of the carcass. A unit (shown in more detail in FIG. 2 of U.S. Pat. No. 6,605,308) of washing system 210 is designed to remove external contaminates from whole birds as they are processed and conveyed via the EVIS overhead conveyor system. While the unit reduces water consumption over conventional cleaning methods, it consumes sufficient amounts to effectively clean as designed.

The unit can be installed on-line in a vertical and left to right position to more fully receive the size and shape of the bird. Measurements of shackle length, shackle centers and height above the floor, as well as, bird weight are used in the custom manufacturing of each unit.

The unit is designed to clean each bird using a combination of brushes and hypobromous acid solution action. Acid solution spray headers spray acid solution onto the brushes to prevent cross-contamination. The main spray headers spray acid solution onto the bird and can also spray acid solution directly onto the carcass. As the bird enters the cabinet hung by the hocks, a sheet of acid solution, for example, having a concentration of about 30-120 ppm hypochlorous acid delivered at a pressure of at least 50 psi, preferably at approximately 80 psi, flushes the hock and trailing drum area on the breast side. A second sheet of acid solution cleans the leading drum area on the backside. At the same time, contact is made by the brushes. The brushes can be designed to rotate down on the breast side and reach into the wing area. The brush on the backside can be designed to rotate up to more closely follow the contour of the bird and lift the tail. As the bird continues through the unit, the brushes and water clean the bird beginning at the top and working toward the bottom.

The birds continue through the process 205 and are further processed through locations 246, 248, 250, 252, 254, 256 and 258 until entering washing system 220. This second pathogen reduction location 220 is located in the post inside/outside bird washer (IOBW) area. Hypobromous acid solution is sprayed on the carcass as it goes through the washer system 220, which may comprise a unit similar to the brush unit of washing system 210. After it exits the washing system 220, the carcass will go to the final trim/inspection station.

The birds continue through the process 205 and are further processed through the pre-chiller 260, post-chiller 262 and further final processing 264. A third pathogen reduction location 230 is in the chiller area of the process 205, and processes chiller water used in the post chiller 262. Here, hypobromous acid solution is added to the chiller water, at the desired concentration, typically about 30-120 ppm, to control growth of undesirable microorganisms in the chiller. An average acid concentration can be about 30 to about 50 ppm for not only this station 230 but all other locations in the process line 205 where the hypobromous acid solution is applied.

It can be seen from the above description that systems and methods are provided employing improved sanitizing agents and solutions for controlling contamination and/or reducing pathogens in food processing plants.

While exemplary embodiments have been described for the production and use of improved sanitizing agents and solutions, in particular, hypobromous acid solutions to control contaminants and/or reduce pathogens in food processing plants, it will be understood that those skilled in the art would recognize that one or more other systems and methods may be used instead. It will also be apparent to those skilled in the art that the systems and methods described above are not limited to use in meat processing plants, in particular poultry processing plants, but instead may be used in other food processing plants.

It should be emphasized that the above-described embodiments of the present systems and methods, particularly, any “preferred” embodiments, are merely possible examples of implementations, merely set forth for a clear understanding of the principles of the present disclosure. Many variations and modifications may be made to the above-described embodiment(s) without departing substantially from the spirit and principles of the present disclosure and its equivalents. All such modifications and variations are intended to be included herein within the scope of this disclosure and protected by the following claims.

What is claimed is:

1. A method for producing hypobromous solution comprising:
combining a pressurized solution of chlorinated carbonic acid with an amount of bromine sufficient to produce a pressurized hypobromous acid solution.

2. The method of claim 1, wherein the hypobromous solution comprises less than about 10 percent hypochlorous acid.

3. The method of claim 2, wherein the pH of the hypobromous acid solution is less than about 8.5.

4. The method of claim 1, wherein the chlorinated carbonic acid solution is at pressure of at least 50 psig.

5. The method of claim 1, wherein the pressurized hypobromous solution is at least about 25 psig.

6. A system for producing hypobromous acid comprising
a carbonic acid source in fluid communication with a chlorinator element for producing a chlorinated carbonic acid solution; and
a bromine source in fluid communication with the carbonic acid solution, wherein the combination of the chlorinated carbonic acid with the bromine source produces hypobromous acid solution.

7. The system of claim 6, wherein the hypobromous acid is at a pH of about 8.5 or less.

8. The system of claim 6, wherein the bromine source is combined with an amount of chlorinated carbonic acid solution to produce hypobromous acid comprising less than about 10% hypochlorous acid.

9. The system of claim 6, wherein the amount of chlorinated carbonic acid combined with the bromine source is regulated to produce a hypobromous acid solution at a pH of about 6 to about 8.

10. The system of claim 6, wherein the carbonic acid solution is pressurized.

11. The system of claim 6, wherein the hypobromous acid solution is pressurized.

12. The system of claim 11, wherein the hypobromous acid solution is at a pressure of about 50 psi or greater.

13. A method for controlling contamination of a surface using the system of claim 12.

14. A method for controlling contamination in a food processing plant, comprising the steps of
a) providing a bromine solution;
b) adding an oxidizer to the bromine solution to form hypobromous acid solution;
c) controlling the pH of the hypobromous solution to about 8.5 or less; and
d) using the hypobromous acid solution to control contamination in said food processing plant.

15. The method of claim 14, wherein the oxidizer is selected from the group consisting of monopersulfate, hydrogen peroxide percarbonate, ozone, and a chlorine source.

16. The method of claim 14, wherein the concentration of hypobromous acid in the solution used is between about 30 and about 120 ppm.

17. The method of claim 14 wherein the oxidizer is a chlorine source and hypochlorous acid is also produced, wherein the ratio of hypobromous acid to hypochlorous acid used in the plant is in the range of about 1:1 to about 1:5.

18. The method of claim 14, wherein the pH is in the range of about 6 to about 8.

19. The method of claim 14, wherein the pH is controlled by the selective addition of an acid.

20. The method of claim 19, wherein the acid is carbonic acid.
